(19) United States
(12) Patent Application Publication
(10) Pub. No.: US 2011/0187027 A1
(43) Pub. Date: Aug. 4, 2011

(54) MANUFACTURING METHOD OF POWER TRANSMISSION SYSTEM MOLDED PRODUCT AND APPARATUS THEREOF

(75) Inventors: Masanobu MIYAZAKI, TOCHIGI (JP); Hiroyuki FUJITA, TOCHIGI (JP); Shinichi SAKAIDA, TOCHIGI (JP)

(73) Assignee: SHOWA CORPORATION, SAITAMA (JP)

(21) Appl. No.: 12/888,516

(22) Filed: Sep. 23, 2010

(30) Foreign Application Priority Data
Jan. 29, 2010 (JP) 2010-017619

(51) Int. Cl. B28B 1/093

(52) U.S. Cl. 264/427; 425/3

(57) ABSTRACT

A manufacturing method of a power transmission system molded product by infusing resin constituents prepared by adding an additive composed of a magnetic material to a molten resin into a cavity of a metallic mold and solidifying the resin constituents, wherein the additive composed of the magnetic material is oriented in a fixed direction by applying a magnetic field to a resin molded product infused into the metallic mold before solidification by a magnetic field orientation structure provided in the metallic mold.

### BACKGROUND OF THE INVENTION

1. Field of the Invention

The present invention relates to a manufacturing method of a power transmission system molded product including a power transmission wheel such as a worm wheel, a gear such as a spur gear, a belt pulley, and a sprocket gear, and an apparatus thereof.

2. Description of the Related Art

A worm wheel produced by infusing a molten resin into a cavity of a metallic mold and solidifying the molten resin, as described in Japanese Patent No. 4331863, is known as a worm wheel used for power transmission systems that transmit driving force of a motor to a steering shaft in an electric power steering apparatus.

On the other hand, a resin molded product that is formed by infusing resin constituents prepared by adding a reinforcing material or the like as an additive to a molten resin into a cavity of a metallic mold to attempt to increase strength of the resin molded product is also known.

To increase strength of a worm wheel described in Japanese Patent No. 4331863, infusing resin constituents prepared by adding a reinforcing material or the like to a molten resin into a cavity of a metallic mold and solidifying the resin constituents can be considered. However, the direction of orientation of a reinforcing material or the like (for example, the orientation in the longitudinal direction of the reinforcing material composed of long particles (or fibrous particles) such as iron pieces) in resin constituents that are infused into the cavity of the metallic mold for solidification is decided by the direction of flow of a molten resin infused into the cavity of the metallic mold and cannot be controlled. Therefore, the direction of orientation of the reinforcing material or the like cannot be controlled in accordance with the purpose such as attempting to increase strength.

### SUMMARY OF THE INVENTION

An object of the present invention is to make it possible to control the direction of orientation of an additive in accordance with the purpose of addition when manufacturing, for example, power transmission wheels composed of resin constituents containing the additive.

The present invention relate to a manufacturing method of a power transmission system molded product by infusing resin constituents prepared by adding an additive composed of a magnetic material to a molten resin into a cavity of a metallic mold and solidifying the resin constituent. The additive composed of the magnetic material is oriented in a fixed direction by applying a magnetic field to a resin molded product infused into the metallic mold before solidification by a magnetic field orientation structure provided in the metallic mold.

The present invention relate to a manufacturing apparatus of a power transmission system molded product by infusing resin constituents prepared by adding an additive composed of a magnetic material to a molten resin into a cavity of a metallic mold and solidifying the resin constituents. A magnetic field orientation structure that applies a magnetic field to a resin molded product infused into the metallic mold before solidification to orient the additive composed of the magnetic material in a fixed direction is provided in the metallic mold.

### BRIEF DESCRIPTION OF THE DRAWINGS

The present invention will be more fully understood from the detailed description given below and from the accompanying drawings which should not be taken to be a limitation on the invention, but are for explanation and understanding only.

The drawings:

FIG. 1 is a schematic view showing a power transmission wheel;

FIGS. 2A and 2B are schematic views showing a manufacturing method according to a first embodiment;

FIGS. 3A and 3B are schematic views showing a manufacturing method according to a second embodiment;

FIGS. 4A and 4B are schematic views showing a manufacturing method according to a third embodiment;

FIGS. 5A and 5B are schematic views showing a manufacturing method according to a fourth embodiment; and

FIGS. 6A and 6B are schematic views showing a manufacturing method according to a fifth embodiment.

### DESCRIPTION OF THE PREFERRED EMBODIMENTS

As embodiments of the present invention, manufacturing methods of a wheel molded product 1 to be a power transmission wheel constituting a worm wheel, a gear such as a spur gear, a belt pulley, a sprocket gear or the like will be described.

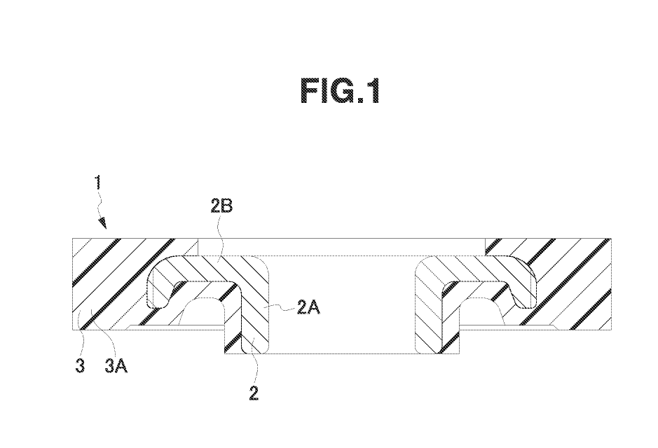

As shown in FIG. 1, the wheel molded product 1 has a resin layer 3 formed on an outer circumference of an insert fitting 2 and constitutes, for example, a gear by carrying out gear cutting on an outer circumferential surface of the resin layer 3. With the insert fitting 2, the wheel molded product 1 ensures strength by constituting a boss 2A and a plurality of arms 2B extending radially. The wheel molded product 1 also attempts to keep meshing sound with a mating gear quiet by constituting a rim with teeth from the resin layer 3.

Sintered metal or steel can be used as metal constituting the insert fitting 2.

As a resin constituting the resin layer 3, reinforced plastics such as a polyphthalamide resin (PPA), polyamide resin (PA), polyether ether ketone resin (PEEK), and polyether nitrile resin (PEN) into which reinforced fiber such as carbon fiber and glass fiber is mixed in advance.

However, the wheel molded product 1 is produced by adding an additive as a reinforcing material to a raw material pellet before the resin constituting the resin layer 3 is formed, with the additive composed of a magnetic material. Ferrite composed of long particles (or fibrous particles) can be adopted as such an additive composed of a magnetic material.

Embodiments of the present invention to manufacture the wheel molded product 1 will be described below.

### First Embodiment

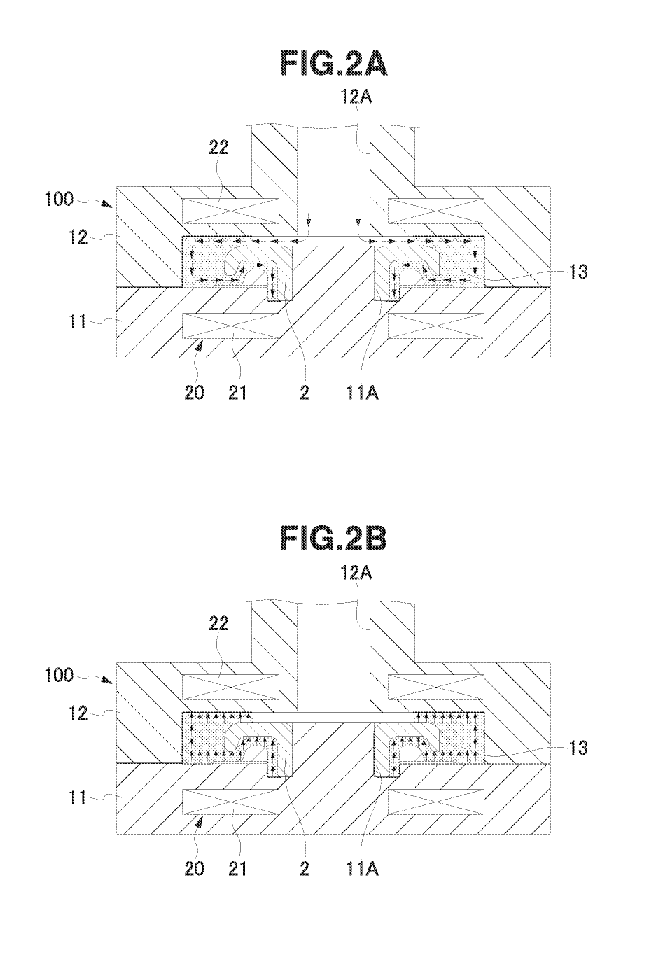

### FIG. 2A, FIG. 2B

A metallic mold 100 shown in FIGS. 2A and 2B is a metallic mold for both molding and orientation and a male mold 12 is matched to a female mold 11 to form a molding cavity 13 of the resin layer 3 of the wheel molded product 1. The female mold 11 includes a boss hole fitting portion 11A of the insert fitting 2 in the central part of the cavity 13 and the male mold 12 includes a bung hole 12A in an upper part of the cavity 13.

The metallic mold 100 is provided with a magnetic field orientation structure 20 internally or the like. The magnetic field orientation structure 20 is constituted of electromagnets 21 (or permanent magnets) embedded in each portion in a circumferential direction facing one side of the cavity 13 in a tooth width formation direction inside the female mold 11 and electromagnets 22 (or permanent magnets) embedded in each portion in the circumferential direction facing the other side of the cavity 13 in the tooth width formation direction inside the male mold 12. Accordingly, resin constituents infused into the cavity 13 of the metallic mold 100 are sandwiched between the electromagnets 21 and the electromagnets 22 of the magnetic field orientation structure 20 in the tooth width formation direction of the cavity 13 so that an additive composed of a magnetic material added to the resin constituents is oriented in a direction along the tooth width formation direction of the cavity 13.

Therefore, the wheel molded product 1 is formed by using the metallic mold 100 as follows:

(1) Set the insert fitting 2 of the wheel molded product 1 to the cavity 13 of the metallic mold 100.

(2) Infuse the aforementioned resin constituents prepared by adding an additive composed of a magnetic material to a molten resin into the cavity 13 of the metallic mold 100 by injection molding (FIG. 2A). Arrows in FIG. 2A indicate the direction of flow of the molten resin infused into the cavity 13.

(3) Apply a magnetic field to the resin constituents by turning on the magnetic field orientation structure 20 (the electromagnets 21, 22) provided in the metallic mold 100 before the resin constituents infused into the cavity 13 of the metallic mold 100 and described in (2) being solidified (the molten resin is in a molten state or a semi-solid state). Accordingly, the additive composed of a magnetic material is oriented in a fixed direction causing the longitudinal direction of long particles of the wheel molded product 1 to follow the tooth width direction thereof (FIG. 2B). Arrows in FIG. 2B indicate the direction of orientation of the additive.

The magnetic field orientation structure 20 may apply a magnetic field to the resin constituents from the start of infusion of the molten resin described in (2).

(4) After the resin constituents described in (3) are solidified, pull out the wheel molded product 1 from the metallic mold 100. Obtain a gear such as a worm wheel including teeth by carrying out gear cutting on an outer circumferential surface of the resin layer 3 of the pulled-out wheel molded product 1.

According to the present embodiment, operation effects shown below are achieved.

An additive composed of a magnetic material is added to a molten resin. Then, a magnetic field is applied by the magnetic field orientation structure 20 provided in the metallic mold 100 to resin constituents infused into the metallic mold 100 before solidification to orient the additive composed of a magnetic material in a fixed direction. Therefore, the direction of orientation of the additive can be controlled to align in a fixed direction in accordance with the purpose of addition.

In the manufacture of worm wheels or the like, the orientation of the longitudinal direction (the direction of orientation) of a reinforcing material as an additive can be aligned in the tooth width direction in accordance with the purpose of addition.

### Second Embodiment

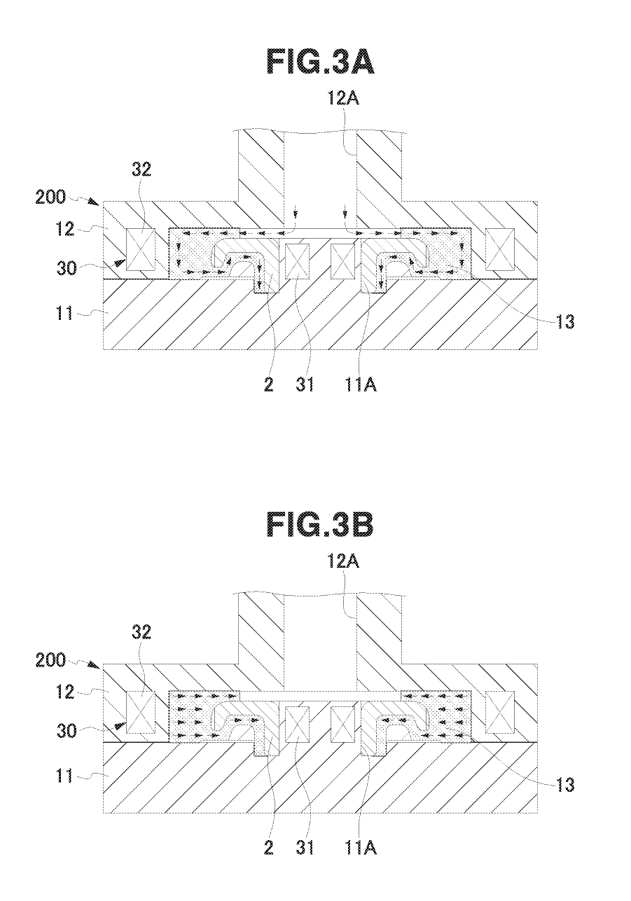

### FIG. 3A, FIG. 3B

In the second embodiment shown in FIGS. 3A and 3B, a metallic mold 200 for both molding and orientation similar to the metallic mold 100 in the first embodiment shown in FIGS. 2A and 2B is used.

The metallic mold 200 is different from the metallic mold 100 in that, instead of the magnetic field orientation structure 20, a magnetic field orientation structure 30 is contained. The magnetic field orientation structure 30 is constituted of electromagnets 31 (or permanent magnets) embedded in each portion in the circumferential direction facing an inner circumferential side of the cavity 13 in a radial direction inside the female mold 11 and electromagnets 32 (or permanent magnets) embedded in each portion in the circumferential direction facing an outer circumferential side of the cavity 13 in the radial direction inside the male mold 12. Accordingly, resin constituents infused into the cavity 13 of the metallic mold 200 are sandwiched between the electromagnets 31 and the electromagnets 32 of the magnetic field orientation structure 30 in the radial direction of the cavity 13 so that an additive composed of a magnetic material and added to the resin constituents is oriented in a direction along the radial direction of the cavity 13.

Therefore, in the second embodiment, of the formation procedures in (1) to (4) described above for the metallic mold 100 in the first embodiment, (1), (2) (FIG. 3A), and (4) are performed in the same manner and (3) is performed as described below: A magnetic field is applied to the resin constituents by turning on the magnetic field orientation structure 30 (the electromagnets 31, 32) provided in the metallic mold 200. Accordingly, the additive composed of a magnetic material is oriented in a fixed direction by causing the longitudinal direction of long particles of the wheel molded product 1 to follow the radial direction thereof (FIG. 3B). Arrows in FIG. 3A indicate the direction of flow of the molten resin infused into the cavity 13. Arrows in FIG. 3B indicate the direction of orientation of the additive.

### Third Embodiment

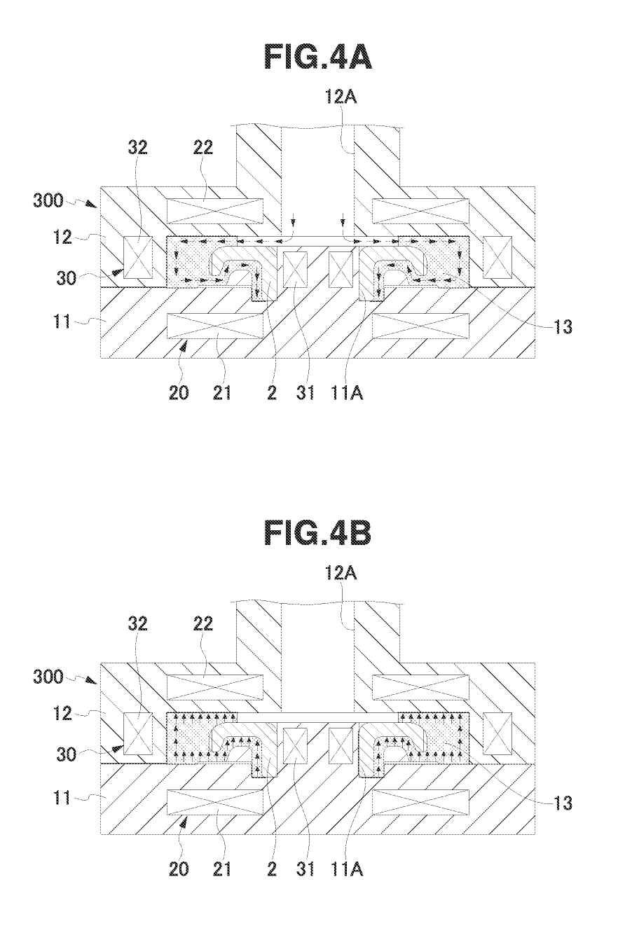

### FIG. 4A, FIG. 4B

A metallic mold 300 according to the third embodiment shown in FIGS. 4A and 4B includes two magnetic field orientation structure having different directions of orientation, in the present embodiment, the magnetic field orientation structure 20 in the tooth width direction in the first embodiment and the magnetic field orientation structure 30 in the radial direction in the second embodiment.

Therefore, in the third embodiment, while using the single metallic mold 300 for both molding and orientation, the formation procedures in (1) to (4) described above according to one of the first and second embodiments can be performed by selectively turning on one of the magnetic field orientation structures 20 and 30 so that the direction of orientation to be given to the additive composed of a magnetic material can freely be selected. FIG. 4B shows an orientation state along the tooth width direction in which the magnetic field orientation structure 20 is turned on. Arrows in FIG. 4A indicate the direction of flow of the molten resin infused into the cavity 13. Arrows in FIG. 4B indicate the direction of orientation of the additive.

### Fourth Embodiment

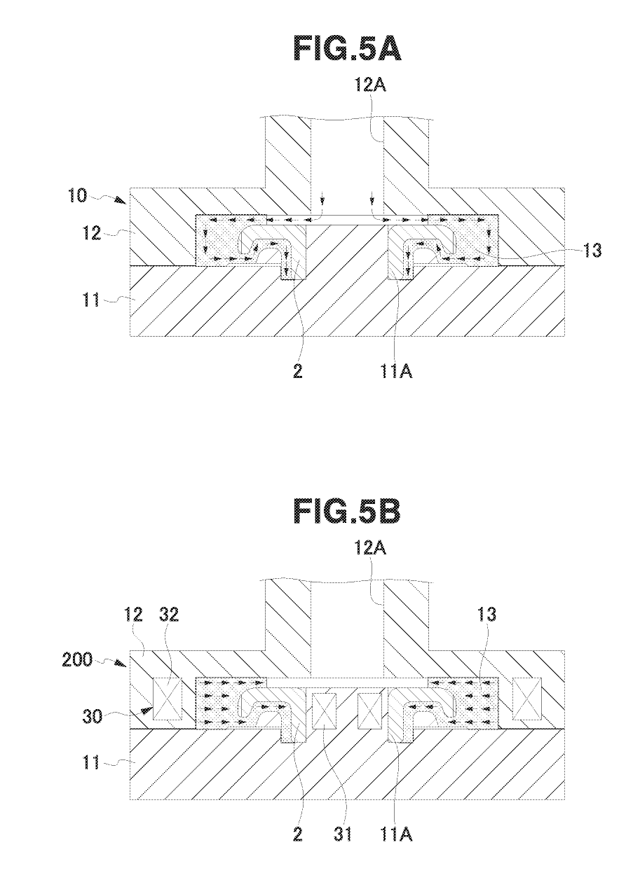

### FIG. 5A, FIG. 5B

The fourth embodiment shown in FIGS. 5A and 5B uses the metallic mold 200 in the second embodiment (or the metallic mold 100 in the first embodiment or the metallic mold 300 in the third embodiment) as a metallic mold for both molding and orientation together with a metallic mold 10 dedicated to forming.

The metallic mold 10 is a metallic mold obtained by removing the magnetic field orientation structure 30 from the metallic mold 200 and is formed by injection molding of the aforementioned resin constituents prepared by adding an additive composed of a magnetic material to a molten resin using the cavity 13 of the metallic mold 10. Then, the wheel molded product 1 formed by the metallic mold 10 and in a semi-solid state is transferred from the from the cavity 13 of the metallic mold 10 to the cavity 13 of the metallic mold 200 to orient the additive composed of a magnetic material in the wheel molded product 1 in the same manner as in the second embodiment using the magnetic field orientation structure 30 of the metallic mold 200. Arrows in FIG. 5A indicate the direction of flow of the molten resin infused into the cavity 13. Arrows in FIG. 5B indicate the direction of orientation of the additive.

### Fifth Embodiment

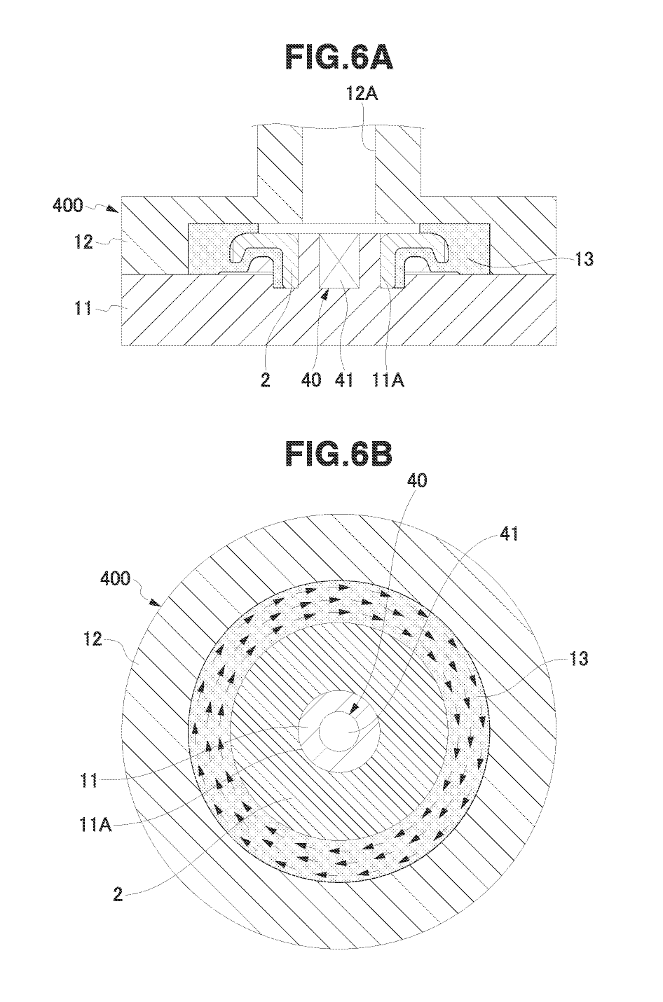

### FIG. 6A, FIG. 6B

A metallic mold 400 for both molding and orientation according to the fifth embodiment shown in FIGS. 6A and 6B is provided with a magnetic field orientation structure 40 composed of a circular electromagnet 41 (or a permanent magnet) in the boss hole fitting portion 11A of the female mold 11 (FIG. 6A). Accordingly, the electromagnet 41 of the magnetic field orientation structure 40 orients an additive composed of a magnetic material and added to resin constituents infused into the cavity 13 of the metallic mold 400 in a direction along the circumferential direction of the cavity 13.

Therefore, in the fifth embodiment, of the formation procedures in (1) to (4) described above for the metallic mold 100 in the first embodiment, (1), (2), and (4) are performed in the same manner and (3) is performed as described below: A magnetic field is applied to the resin constituents by turning on the magnetic field orientation structure 40 (the electromagnet 41) provided in the metallic mold 400. Accordingly, the additive composed of a magnetic material is oriented in a fixed direction by causing the longitudinal direction of long particles of the wheel molded product 1 to follow the circumferential direction thereof (FIG. 6B). Arrows in FIG. 6B indicate the direction of orientation of the additive.

As heretofore explained, embodiments of the present invention have been described in detail with reference to the drawings. However, the specific configurations of the present invention are not limited to the illustrated embodiments but those having a modification of the design within the range of the presently claimed invention are also included in the present invention.

The present invention relates to a manufacturing method and apparatus of a power transmission system molded product and a magnetic field is applied to a resin molded product infused into the metallic mold before solidification by a magnetic field orientation structure provided in the metallic mold to orient an additive composed of a magnetic material in a fixed direction. Accordingly, the direction of orientation of the additive can be controlled in accordance with the purpose of addition when power transmission wheels composed of resin constituents containing an additive are manufactured.

The additive is not limited to a reinforcing material that attempts to increase strength of a power transmission wheel or the like and various additives for various purposes can be adopted. Moreover, the direction of orientation of an additive can be optimized in accordance with the purpose of the addition.

Although the invention has been illustrated and described with respect to several exemplary embodiments thereof, it should be understood by those skilled in the art that the foregoing and various other changes, omissions and additions may be made to the present invention without departing from the spirit and scope thereof. Therefore, the present invention should not be understood as limited to the specific embodiment set out above, but should be understood to include all possible embodiments which can be encompassed within a scope of equivalents thereof with respect to the features set out in the appended claims.

What is claimed is:

1. A manufacturing method of a power transmission system molded product comprising the steps of infusing resin constituents prepared by adding an additive composed of a magnetic material to a molten resin into a cavity of a metallic mold and solidifying the resin constituents,
orienting the additive composed of the magnetic material in a fixed direction by applying a magnetic field to a resin molded product infused into the metallic mold before solidification by a magnetic field orientation structure provided in the metallic mold.

2. The manufacturing method of a power transmission system molded product according to claim 1, further comprising: providing a plurality of magnetic field orientation structures having different directions of orientation in the metallic mold, and selecting the direction of orientation to be given to the additive composed of the magnetic material by selectively turning on each magnetic field orientation structure.

3. A manufacturing apparatus of a power transmission system molded product by infusing resin constituents prepared by adding an additive composed of a magnetic material to a molten resin into a cavity of a metallic mold and solidifying the resin constituents, wherein
a magnetic field orientation structure that applies a magnetic field to a resin molded product infused into the metallic mold before solidification to orient the additive composed of the magnetic material in a fixed direction is provided in the metallic mold.

4. The manufacturing apparatus of a power transmission system molded product according to claim 3, wherein a plurality of magnetic field orientation structures having different directions of orientation is provided in the metallic mold to make the direction of orientation to be given to the additive composed of the magnetic material selectable by selectively turning on each magnetic field orientation structure.

5. The manufacturing apparatus of a power transmission system molded product according to claim 3, wherein the metallic mold has the cavity formed by matching a male mold to a female mold and
the magnetic field orientation structure is constituted of electromagnets embedded in the male mold and electromagnets embedded in the female mold.

6. The manufacturing apparatus of a power transmission system molded product according to claim 4 wherein the metallic mold has the cavity formed by matching a male mold to a female mold and
the magnetic field orientation structure is constituted of electromagnets embedded in the male mold and electromagnets embedded in the female mold.

7. The manufacturing apparatus of a power transmission system molded product according to claim 3, wherein the metallic mold has the cavity formed by matching a male mold to a female mold and
the magnetic field orientation structure comprises permanent magnets embedded in the male mold and permanent magnets embedded in the female mold.

8. The manufacturing apparatus of a power transmission system molded product according to claim 4, wherein the metallic mold has the cavity formed by matching a male mold to a female mold and
the magnetic field orientation structure comprises of permanent magnets embedded in the male mold and permanent magnets embedded in the female mold.

9. The manufacturing apparatus of a power transmission system molded product according to claim 3, wherein the metallic mold has the cavity formed by matching a male mold to a female mold and
the magnetic field orientation structure has a circular electromagnet contained in the female mold.

10. The manufacturing apparatus of a power transmission system molded product according to claim 4, wherein the metallic mold has the cavity formed by matching a male mold to a female mold and
the magnetic field orientation structure has a circular electromagnet contained in the female mold.

11. The manufacturing apparatus of a power transmission system molded product according to claim 3, wherein the metallic mold has the cavity formed by matching a male mold to a female mold and
the magnetic field orientation structure has a circular permanent magnet contained in the female mold.

12. The manufacturing apparatus of a power transmission system molded product according to claim 4, wherein the metallic mold has the cavity formed by matching a male mold to a female mold and
the magnetic field orientation structure has a circular permanent magnet contained in the female mold.
